(19) United States
(12) Patent Application Publication
(10) Pub. No.: US 2019/0273620 A1
(43) Pub. Date: Sep. 5, 2019

(54) DATA SHARING METHOD AND DATA SHARING SYSTEM

(71) Applicant: ZhongAn Information Technology Service Co., Ltd., Shenzhen (CN)

(72) Inventors: Xiaochuan WU, Shenzhen (CN); Xuefeng LI, Shenzhen (CN); Zejun GAN, Shenzhen (CN)

(21) Appl. No.: 16/416,320

(22) Filed: May 20, 2019

Related U.S. Application Data
(63) Continuation of application No. PCT/CN2018/095782, filed on Jul. 16, 2018.

(30) Foreign Application Priority Data
Jul. 18, 2017 (CN) 201710585991.8

(51) Int. Cl. H04L 9/32; H04L 9/06; H04L 9/30; H04L 9/14; H04L 29/06

(52) U.S. Cl. CPC H04L 9/3255; H04L 9/0637; H04L 2209/38; H04L 9/14; H04L 63/0442; H04L 9/3073

(57) ABSTRACT

A data sharing method includes: reading, by a second participant of a plurality of participants participating in data sharing, first data and a first ring signature from a blockchain; verifying, by the second participant, the first ring signature by using a ring signature verification algorithm according to the public keys of the plurality of participants, the first data and the first ring signature; and using the first data when the second participant verifies that the first ring signature is legal. In the data sharing method according to the embodiments of the present invention, privacy of a data sharer is protected and the data sharer has authority to share data is believed by a verifier, and a responsibility investigation mechanism of the data sharing is established.

### CROSS-REFERENCE TO RELATED APPLICATIONS

This application is a continuation of International Application No. PCT/CN2018/095782 filed on Jul. 16, 2018, which claims priority to Chinese patent application No. 201710585991.8 filed on Jul. 18, 2017. Both applications are incorporated herein by reference in their entireties.

### TECHNICAL FIELD

Embodiments of the present invention relate to the field of communication technologies, and in particular to a data sharing method and a data sharing system.

### BACKGROUND

When multiple parties share data through the network, each party may become a data sharer or a data receiver. When the multiple parties share data, it is often difficult to avoid leaking privacy of the data sharer. That is, each party sharing the data knows which party shares the data. Only in this way, legitimacy of identity of the data sharer is verified and even responsibility investigation is achieved. In some cases, when the data sharer shares the data while exposing the identity of the data sharer, for minimal loss of the privacy, a desensitization process is often used to reduce privacy contents contained in the data. But at the same time, value of the data also falls substantially.

### SUMMARY

In view of this, embodiments of the present invention provide a data sharing method and a data sharing system, in order to ensure that identity privacy data of a data sharer is not exposed, and make a data receiver believe that the data sharer really has authority to share the data.

According to a first aspect, an embodiment of the present invention provides a data sharing method. The data sharing method includes: reading, by a second participant of a plurality of participants participating in data sharing, first data and a first ring signature from a blockchain, each of the plurality of participants has a key pair, and the key pair includes a public key and a private key matching the public key, the first ring signature is generated by a first participant of the plurality of participants by using a ring signature algorithm according to public keys of the plurality of participants, a private key of the first participant and the first data, and the first data and the first ring signature are written into the blockchain; verifying, by the second participant, the first ring signature by using a ring signature verification algorithm according to the public keys of the plurality of participants, the first data and the first ring signature; and using the first data when the second participant verifies that the first ring signature is legal.

In an embodiment of the present invention, the data sharing method further includes: generating a second ring signature, by the second participant, by using the ring signature algorithm according to the public keys of the plurality of participants, a private key of the second participant and second data; and writing the second data and the second ring signature into the blockchain.

In an embodiment of the present invention, the writing the second data and the second ring signature into the blockchain includes: generating a disposable public-private key pair by the second participant; and writing the second data and the second ring signature into the blockchain by the second participant by using the disposable public-private key pair.

In an embodiment of the present invention, the data sharing method further includes: executing a first problem processing program when the second participant verifies that the first ring signature is illegal.

In an embodiment of the present invention, the executing a first problem processing program when the second participant verifies that the first ring signature is illegal includes: executing the first problem processing program when the number of times that the first ring signature is verified to be illegal by the second participant is greater than a first threshold.

In an embodiment of the present invention, the executing the first problem processing program when the number of times that the first ring signature is verified to be illegal by the second participant is greater than a first threshold includes: stopping the data sharing in the blockchain when the number of times that the first ring signature is verified to be illegal by the second participant is greater than the first threshold within a first predetermined time.

In an embodiment of the present invention, before the stopping the data sharing in the blockchain when the number of times that the first ring signature is verified to be illegal by the second participant is greater than the first threshold within a first predetermined time, the method further includes: setting a second predetermined time, by the second participant for claiming an error by the first participant; and recording the number of times that the first ring signature is verified to be illegal within the first predetermined time by the second participant, if the first participant does not claim the error within the second predetermined time.

In an embodiment of the present invention, the data sharing method further includes: reporting an error and executing a second problem processing program, if the second participant finds that the first data is incorrect after using the first data.

In an embodiment of the present invention, the reporting the error and executing a second problem processing program, if the second participant finds that the first data is incorrect after using the first data includes: voting, by the second participant and other participants of the plurality of participants, to confirm whether the first data is incorrect; and performing ring signatures on the first data to find the first participant, by the second participant and the other participants of the plurality of participants, when a proportion of participants that confirm the first data is incorrect exceeds a second predetermined threshold.

In an embodiment of the present invention, the voting, by the second participant and other participants of the plurality of participants, to confirm whether the first data is incorrect includes: setting a third predetermined time, by the second participant, for claiming the error by the first participant; and voting, by the second participant and other participants of the plurality of participants, to confirm whether the first data is incorrect if the first participant does not claim the error within the third predetermined time.

In an embodiment of the present invention, the performing ring signatures on the first data to find the first participant by the second participant and the other participants of the plurality of participants includes: voting, by the second participant and the other participants of the plurality of participants to determine whether it is necessary to seek the first participant; and performing the ring signatures on the first data, by the second participant and the other participants of the plurality of participants, to find the first participant if a proportion of voting results showing that the first participant needs to be sought exceeds a third predetermined threshold.

In an embodiment of the present invention, each key pair is generated by using an asymmetric cryptographic algorithm.

In an embodiment of the present invention, the asymmetric cryptographic algorithm is an elliptic curve cryptography.

In an embodiment of the present invention, the first ring signature is a linkable ring signature.

According to a second aspect, an embodiment of the present invention further provides a data sharing system. The data sharing system includes a memory, a processor, and a computer program stored in the memory and executed by the processor, when the computer program is executed by the processor, the processor implements the following steps: reading, by a second participant of a plurality of participants participating in data sharing, first data and a first ring signature from a blockchain, each of the plurality of participants has a key pair, and the key pair includes a public key and a private key matching the public key, the first ring signature is generated by a first participant of the plurality of participants by using a ring signature algorithm according to public keys of the plurality of participants, a private key of the first participant and the first data, and the first data and the first ring signature are written into the blockchain; verifying, by the second participant, the first ring signature by using a ring signature verification algorithm according to the public keys of the plurality of participants, the first data and the first ring signature; verifying whether the first ring signature is legal by the second participant; and using the first data when the second participant verifies that the first ring signature is legal.

In an embodiment of the present invention, the processor further implements the following steps: generating a second ring signature, by the second participant, by using the ring signature algorithm according to the public keys of the plurality of participants, a private key of the second participant and second data; and writing the second data and the second ring signature into the blockchain.

In an embodiment of the present invention, when implementing the step of writing the second data and the second ring signature into the blockchain, the processor specifically further implements the following steps: generating a disposable public-private key pair by the second participant; and writing the second data and the second ring signature into the blockchain by the second participant according to the disposable public-private key pair.

In an embodiment of the present invention, the processor further implements the following step: executing a first problem processing program by the second participant when the second participant verifies that the first ring signature is illegal.

In an embodiment of the present invention, when implementing the step of executing a first problem processing program when the second participant verifies that the first ring signature is illegal, the processor specifically implements the following step: executing the first problem processing program when the number of times that the first ring signature is verified to be illegal by the second participant is greater than a first threshold.

In an embodiment of the present invention, when implementing the step of executing the first problem processing program when the number of times that the first ring signature is verified to be illegal by the second participant is greater than a first threshold, the processor specifically implements the following step: stopping the data sharing in the blockchain when the number of times that the first ring signature is verified to be illegal by the second participant is greater than the first threshold within a first predetermined time.

In an embodiment of the present invention, when implementing the step of executing the first problem processing program when the number of times that the first ring signature is verified to be illegal by the second participant is greater than a first threshold, the processor specifically implements the following steps: setting a second predetermined time, by the second participant for claiming an error by the first participant; and recording the number of times that the signature is verified to be illegal within the first predetermined time by the second participant if the first participant does not claim the error within the second predetermined time.

In an embodiment of the present invention, the processor further implements the following step: reporting an error and executing a second problem processing program, if the second participant finds that the first data is incorrect after using the first data.

In an embodiment of the present invention, when implementing the step of reporting an error and executing a second problem processing program, if the second participant finds that the first data is incorrect after using the first data, the processor specifically implements the following steps: voting, by the second participant and other participants of the plurality of participants, to confirm whether the first data is incorrect; and performing ring signatures on the first data to find the first participant, by the second participant and the other participants of the plurality of participants, when a proportion of participants that confirm the first data is incorrect exceeds a second predetermined threshold.

In an embodiment of the present invention, when implementing the step of reporting an error and executing a second problem processing program, if the second participant finds that the first data is incorrect after using the first data, the processor specifically further implements the following steps: setting a third predetermined time, by the second participant, for claiming the error by the first participant; and voting, by the second participant and other participants of the plurality of participants, to confirm whether the first data is incorrect if the first participant does not claim the error within the third predetermined time.

In an embodiment of the present invention, when implementing the step of reporting an error and executing a second problem processing program, if the second participant finds that the first data is incorrect after using the first data, the processor specifically further implements the following steps: voting to determine whether it is necessary to seek the first participant by the second participant and the other participants of the plurality of participants; and performing the ring signatures on the first data to find the first participant, by the second participant and the other participants of the plurality of participants, if the proportion of voting results showing that the first participant needs to be sought exceeds a third predetermined threshold.

According to a third aspect, an embodiment of the present invention further provides a computer readable storage medium storing a data sharing program for causing a processor to execute the data sharing method according to any one of the above embodiments.

The data sharing method according to the embodiments of the present invention has the following advantages and beneficial effects.

(1) The identity privacy data of the data sharer can be ensured to be not exposed, and the data sharer really has the authority to share the data is believed by the data receiver (that is, a verifier), even to achieve subsequent responsibility investigation.

(2) The identity privacy of the data sharer may be protected and each participant may be helped to verify whether the identity of the data sharer is legal when the plurality of participants share the data through the network.

(3) The identity privacy of each participant involved in the data sharing may be protected, and verifiable and correctable capabilities may be ensured.

(4) Trust crisis between the parties sharing the data may be solved, and concerns of the participants on privacy protection may be eliminated, and the development of multiple parties data sharing in the network may be promoted.

In addition, the data sharing system according to the embodiments of the present invention also has the above advantages and beneficial effects.

### BRIEF DESCRIPTION OF DRAWINGS

FIG. 1 shows a schematic flowchart of a data sharing method according to an embodiment of the present invention.

FIG. 2 shows a schematic flowchart of a data sharing method according to another embodiment of the present invention.

FIG. 3 shows a schematic flowchart of a data sharing method according to still another embodiment of the present invention.

FIG. 4 shows a schematic flowchart of a data sharing method according to yet still another embodiment of the present invention.

FIG. 5 shows a schematic workflow diagram of a data sharing system according to an embodiment of the present invention.

FIG. 6 shows a schematic diagram of a process of generating a public-private key pair of a data sharing system according to an embodiment of the present invention.

FIG. 7 shows a schematic diagram of a process of generating a ring signature of a data sharing system according to an embodiment of the present invention.

FIG. 8 shows a schematic diagram of a process of verifying a ring signature of a data sharing system according to an embodiment of the present invention.

FIG. 9 shows a schematic structural diagram of a data sharing system according to an embodiment of the present invention.

FIG. 10 shows a schematic structural diagram of a data sharing system according to another embodiment of the present invention.

FIG. 11 shows a schematic structural diagram of a data sharing system according to still another embodiment of the present invention.

FIG. 12 shows a schematic structural diagram of an electronic equipment according to an embodiment of the present invention.

### DETAILED DESCRIPTION

A multi-party data sharing method and system for protecting privacy of a data transmission source according to the present invention will be further described in detail below with reference to accompanying drawings and specific embodiments, but the detailed description imposes no limitation on the present invention.

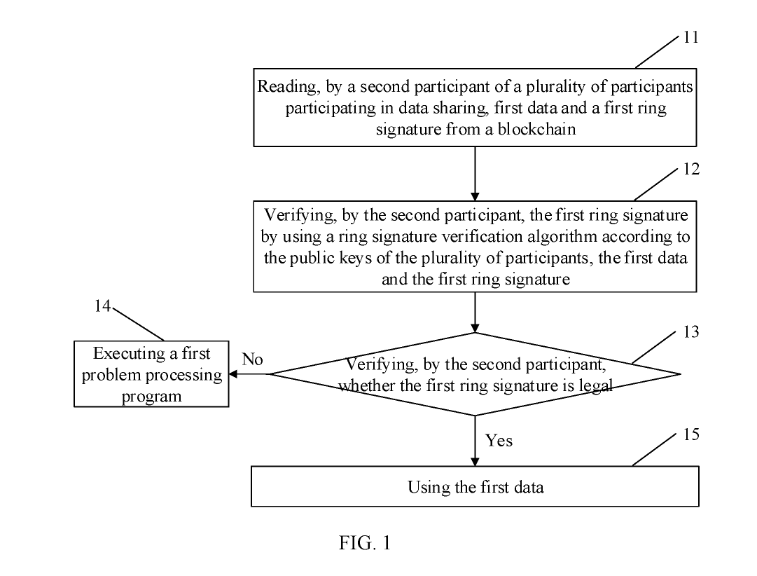

FIG. 1 shows a schematic flowchart of a data sharing method according to an embodiment of the present invention. As shown in FIG. 1, the data sharing method according to the embodiment of the present invention includes the following steps.

11: reading, by a second participant of a plurality of participants participating in data sharing, first data and a first ring signature from a blockchain. Each of the plurality of participants has a key pair, and the key pair includes a public key and a private key matching the public key. The first ring signature is generated by a first participant of the plurality of participants by using a ring signature algorithm according to public keys of the plurality of participants, a private key of the first participant and the first data. The first data and the first ring signature are written into the blockchain.

It may be noted that each participant can be both a data sharer and a verifier. That is, each participant participating in the data sharing can have dual identities. The data sharer refers to the data transmission source mentioned in the following embodiments. It may also be understood that the participants may be nodes or network devices participating in the data sharing.

It may be understood that in the step 11, the first participant refers to the data sharer, and an identity of the second participant refers to the verifier.

12: verifying, by the second participant, the first ring signature by using a ring signature verification algorithm according to the public keys of the plurality of participants, the first data and the first ring signature.

13: verifying, by the second participant, whether the first ring signature is legal. In the step 13, if the second participant verifies that the first ring signature is illegal, and then step 14 is executed; if the second participant verifies that the first ring signature is legal, and then step 15 is executed.

14: executing a first problem processing program.

It may be understood that the first problem processing program may include processing operations such as stopping data sharing, claiming an error and so on. Thereby, adaptability and wide application of the data sharing method according to the embodiments of the present invention may be fully improved. Which processing operation may be included in the first problem processing program is not limited in the embodiments of the present invention.

15: using the first data.

It may be noted that a reason for a verification result is illegal may be that a wrong private key is used by the data sharer or that the data sharer is not one of the participants.

In an actual application process, firstly the first data and the first ring signature are read from the blockchain by the second participant of the plurality of participants participating in the data sharing, and then the first ring signature is verified by the second participant by using the ring signature verification algorithm according to the public keys of the plurality of participants, the first data and the first ring signature. When the second participant verifies that the first ring signature is illegal, the first problem processing program is executed by the second participant, and when the second participant verifies that the first ring signature is legal, the first data is used by the second participant. Each of the plurality of participants has the key pair (each key pair includes a public key and a private key matching the public key). The first ring signature is generated by the first participant of the plurality of participants by using the ring signature algorithm according to the public keys of the plurality of participants, the private key of the first participant and the first data. The first data and the first ring signature are written into the blockchain.

In the data sharing method according to the embodiments of the present invention, by means of generating the ring signature by the data sharer according to the private key of the data sharer, the public keys of the participants and the shared data, and writing the generated ring signature and the shared data into the blockchain, and verifying the ring signature in the blockchain by the verifier by using the ring signature verification algorithm, and determining whether to use the shared data according to the verification result, privacy of the data sharer is protected and the data sharer has authority to share the data is believed by the verifier, and a responsibility investigation mechanism of the data sharing is established.

In an embodiment of the present invention, the executing a first problem processing program (the step 14) includes executing the first problem processing program when the number of times that the ring signature is verified to be illegal by the second participant is greater than a first threshold.

It may be understood that in the embodiment of the present invention, a false alarm probability rate is reduced by using the first threshold to limit the number of illegal times required for executing the first problem processing program.

It may be noted that a specific value of the first threshold may be set according to an actual situation, so as to fully improve the adaptability and the wide application of the data sharing method according to the embodiments of the present invention. It is not uniformly limited in the embodiments of the present invention.

Since operation fluency of a whole system may be affected by a processing of illegal verifications, a case with a high occurrence frequency in which the verification result is illegal may be dealt by using the first threshold. For example, if the cumulative number of times of the illegal verifications does not exceed the first threshold within a period of time, each participant ignores the illegal verifications. On the contrary, a mess may be made by one or more participants, or the network of the participants may be infiltrated to attack by an outsider. At this moment, the data sharing in the blockchain needs to be stopped.

In another embodiment of the present invention, the executing the first problem processing program when the number of times that the ring signature is verified to be illegal by the second participant is greater than a first threshold includes: stopping the data sharing in the blockchain when the number of times that the ring signature is verified to be illegal by the second participant is greater than the first threshold within a first predetermined time.

It may be understood that in the embodiment of the present invention, the false alarm probability rate is further reduced and accuracy of feedback is improved by using the first predetermined time to further limit an execution condition of the first problem processing program.

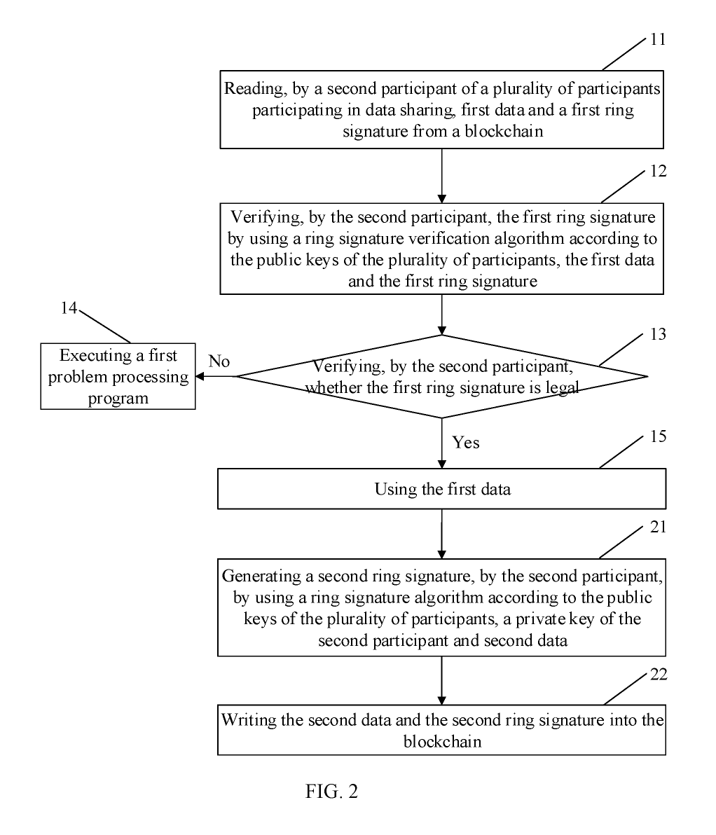

FIG. 2 shows a schematic flowchart of a data sharing method according to another embodiment of the present invention. As shown in FIG. 2, the data sharing method according to the embodiment of the present invention further includes the following steps after using the first data (the step 15).

21: generating a second ring signature, by a second participant, by using a ring signature algorithm according to public keys of a plurality of participants, a private key of the second participant and second data.

It may be understood that the second data may be the same as or different from first data. The second data is the same as the first data refers to that shared data is not modified by the second participant. The second data is different from the first data refers to that the shared data is modified by the second participant, and the modified shared data is rewritten into the blockchain.

22: writing the second data and the second ring signature into the blockchain.

In addition, it may be understood that in the step 21, an identity of the second participant is a data sharer.

In an actual application process, when the second participant verifies that a first ring signature is legal, the first data is used by the second participant, and then the second ring signature is generated by the second participant by using the ring signature algorithm according to the public keys of the plurality of participants, the private key of the second participant and the second data, and then the second data and the second ring signature are written into the blockchain.

In the data sharing method according to the embodiments of the present invention, by means of generating the second ring signature by the second participant (at this time the second participant is the data sharer) by using the ring signature algorithm according to the private key of the second participant, the public keys of the plurality of participants and the second data after using the first data by the second participant (at this time the second participant is a verifier), and then writing the second data and the second ring signature into the blockchain, the data shared by other participants may be obtained by the second participant, and the data may be written into the blockchain according to an actual situation. That is, the data sharing based on a premise of protecting privacy is realized by the second participant according to dual identities of the verifier and the data sharer.

In an embodiment of the present invention, the step 22 includes generating a disposable public-private key pair by the second participant, and writing the second data and the second ring signature into the blockchain by the second participant according to the disposable public-private key pair.

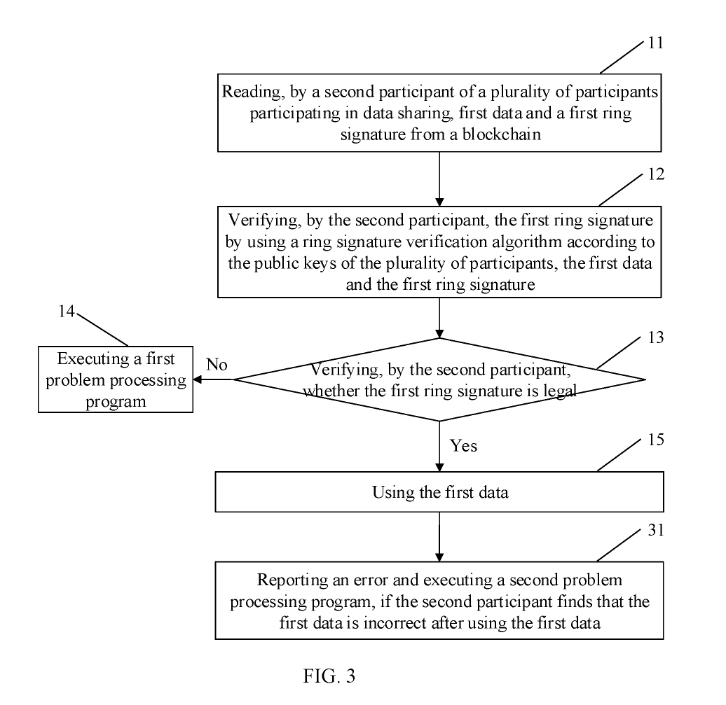

FIG. 3 shows a schematic flowchart of a data sharing method according to still another embodiment of the present invention. As shown in FIG. 3, the data sharing method according to the embodiment of the present invention further includes the following steps after using the first data (the step 15).

31: reporting an error and executing a second problem processing program, if a second participant finds that the first data is incorrect after using the first data.

It may be understood that the second problem processing program may include processing operations such as finding a data sharer and so on. Therefore, adaptability and wide application of the data sharing method according to the embodiments of the present invention are fully improved, and a precondition for realizing responsibility investigation of the data sharing is provided.

In an actual application process, when the second participant verifies that the first ring signature is legal, the first data is used by the second participant, and then after using the first data, if the second participant finds that the first data is incorrect, the second participant reports the error and executes the second problem processing program.

In the data sharing method according to the embodiments of the present invention, by means of reporting the error and executing the second problem processing program by the second participant, when the first data is found to be incorrect after using the first data, correctness of the shared data is verified. Therefore, an emergency treatment is realized when the shared data is found to be incorrect, and accuracy of the data sharing method is improved. In addition, a precondition for tracing a source of the shared data is provided according to the embodiments of the present invention.

In an embodiment of the present invention, the reporting an error and executing a second problem processing program, if a second participant finds that the first data is incorrect after using the first data (the step 31) includes: voting, by the second participant and other participants of a plurality of participants, to confirm whether the first data is incorrect; performing ring signatures on the first data to find a first participant, by the second participant and the other participants of the plurality of participants, when the participants who confirm that the first data is incorrect account for a proportion of all the participants exceeds a second predetermined threshold.

It may be understood that a specific value of the second threshold may be set according to an actual situation, this is not uniformly limited in the embodiment of the present invention.

Data availability of a whole system may be affected by a processing of reporting the error. Since cognitive ability of each party may have an impact, one party may think that the first data is incorrect while another party may think that the first data is correct. Therefore, the second threshold is predetermined. If the voting results show that the participants who confirm that the first data is incorrect account for a proportion of all the participants exceeds the second threshold, it indicates that there may be a participant who deliberately writes the incorrect data. At this time, it is necessary to find out the data sharer who writes the incorrect data, thereby realizing responsibility investigation. For example, each party writes a linkable ring signature for the shared data, and digitally signs the linkable ring signature to prove an identity of the party. A person who does not submit the linkable ring signature or provides the linkable ring signature linked to a known linkable ring signature receives a corresponding punishment. It may be noted that an error correction measure may be customized according to wishes of the participants.

In the embodiment of the present invention, possibility that the shared data is subjectively identified to be incorrect is reduced by voting to verify whether the shared data is incorrect. In addition, the source of the shared data is traced by using the ring signatures to find the first participant.

In another embodiment of the present invention, the voting, by the second participant and other participants of the plurality of participants, to confirm whether the first data is incorrect includes: setting a third predetermined time, by the second participant, for claiming the error by the first participant; voting, by the second participant and other participants of the plurality of participants, to confirm whether the first data is incorrect if the first participant does not claim the error within the third predetermined time.

It may be understood that a specific value of the third predetermined time may be set according to an actual situation, which is not uniformly limited in the embodiment of the present invention.

In the embodiment of the present invention, by means of setting the third predetermined time, by the second participant (that is, a verifier), for claiming the error by the first participant (that is, the data sharer), flexibility of the data sharing method according to the embodiment of the present invention is improved.

In another embodiment of the present invention, the performing ring signatures on the first data to find the first participant, by the second participant and the other participants of the plurality of participants, when the participants who confirm that the first data is incorrect account for a proportion of all the participants exceeds a second predetermined threshold includes: voting, by the second participant and the other participants of the plurality of participants, to determine whether it is necessary to seek the first participant; performing the ring signatures on the first data, by the second participant and the other participants of the plurality of participants, to find the first participant, if voting results show that the participants consider that the first participant needs to be sought account for a proportion of all the participants exceeds a third predetermined threshold.

It may be understood that a specific value of the third threshold may be set according to an actual situation, which is not uniformly limited in the embodiment of the present invention.

In the embodiment of the present invention, if the voting results show that the participants who confirm that the first data is incorrect account for a proportion of all the participants exceeds the second predetermined threshold, it indicates that the participants reach a common perception that the first data is incorrect. At this time, the first data is not used by the participants, and it is not necessary to investigate a data transmission source. A result of forcibly investigating the data transmission source is likely to be that a party being investigated has no place to stand and then exits. On another level, the embodiment of the present invention is for serving the parties who attempt to share the data in good faith. If a party is dishonest and does not repent, then it is also duty-bound to investigate responsibility of the party. Therefore, whether to investigate may be determined by voting. If the voting results show that the participants consider that the data transmission source that writes the incorrect first data needs to be sought account for a proportion of all the participants exceeds the third predetermined threshold, then each participant usually writes the linkable ring signature for the first data, and digitally signs the linkable ring signature to prove an identity of the participant. The person who does not submit the linkable ring signature or provides the linkable ring signature linked to a known linkable ring signature receives the corresponding punishment.

In the embodiment of the present invention, only when the voting results made by the participants show that the participants consider that the first participant needs to be sought account for a proportion of all the participants exceeds the third predetermined threshold, a seeking operation is performed. Therefore, the wishes of the participants may be fully respected.

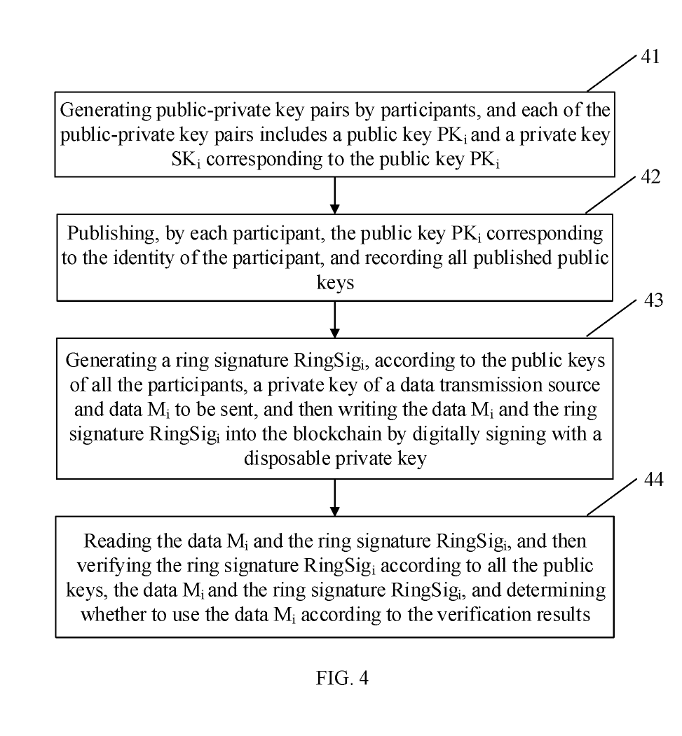

FIG. 4 shows a schematic flowchart of a data sharing method according to yet still another embodiment of the present invention. As shown in FIG. 4, the data sharing method according to the embodiment of the present invention includes a plurality of participants. The plurality of participants are jointly connected to a blockchain to share data. The data sharing method includes the following steps.

41: using an asymmetric cryptographic algorithm, by each of the plurality of participants, to generate a public-private key pair representing an identity of the participant. Each public-private key pair includes a public key PKᵢ and a private key SKᵢ corresponding to the public key PKᵢ.

42: publishing, by each participant, the public key PKᵢ corresponding to the identity of the participant, and recording all published public keys PK₁, PK₂, . . . PKᵢ . . . , PKn.

43: generating a ring signature RingSigᵢ, by using a ring signature algorithm, according to the public keys PK₁, PK₂, . . . PKᵢ . . . , PKn of all the participants, a private key of a data transmission source and data Mi to be sent, and then using the asymmetric cryptographic algorithm to generate a disposable public-private key pair by the data transmission source, and writing the data Mᵢ and the ring signature RingSigᵢ into the blockchain by using a disposable private key of the disposable public-private key pair, when the data transmission source of the plurality of participants intends to send the data Mi to other participants.

44: reading the data Mᵢ and the ring signature RingSigᵢ from the blockchain, and then verifying the ring signature RingSigᵢ by using a ring signature verification algorithm according to the public keys PK₁, PK₂, . . . PKᵢ, . . . PKn, the data n and the ring signature RingSigᵢ, when any one of other participants intends to use the data Mᵢ, and using the data Mᵢ if a verification result is legal, and doing not use the data Mᵢ if the verification result is illegal.

In some embodiments, the asymmetric cryptographic algorithm refers to an elliptic curve cryptography.

In some embodiments, the ring signature refers to the linkable ring signature.

It may be understood that, the linkable ring signature refers to a ring signature technology that a situation in which two signatures have a same specific field when a same user signs same information repeatedly, and then a conclusion that the two signers are the same person may be got according to the situation. The linkable ring signature can ensure that the same person can sign a same content only once, and duplicate signatures may cause that the generated signature and the previous signature are found to be generated by the same person. It may be noted that the identity of the signer may not directly exposed according to the duplicate signatures, but the identity of the signer may be exposed according to a side message generated by the duplicate signatures. In the embodiments of the present invention, the ring signature having the above effects is referred to as the linkable ring signature, which may be implemented in a variety of ways.

In some embodiments, in the step 44, if the verification result is illegal, doing not use the data Mᵢ and entering into a first problem processing program. The first problem processing program includes: recording the number of illegal verification results within a period of time, if the number of the illegal verification results exceeds a first threshold, stopping the data sharing in the blockchain.

In some embodiments, before recording the number of the illegal verification results, a set time period is reserved for the data transmission source to claim an error. If no one claims the error beyond the set time period, and then the number of the illegal verification results is recorded.

In some embodiments, the data sharing method mentioned above further includes: reporting the error and executing a second problem processing program, if the data is found to be incorrect after used. The second problem processing program includes: voting, by all the participants, to confirm whether the data Mᵢ is incorrect, and performing the ring signatures on the incorrect data by all the participants to find the data transmission source that writes the incorrect data, if the voting results show that the participants who confirm that the data Mᵢ is incorrect account for a proportion of all the participants exceeds a second predetermined threshold.

In some embodiments, in the step of reporting the error and executing a second problem processing program, if the data is found to be incorrect after used, before voting to confirm whether the data Mᵢ is incorrect, a set time period is reserved for the data transmission source to claim the error. If no one claims the error beyond the set time period, and then voting to confirm whether the data Mᵢ is incorrect.

In some embodiments, in the step of reporting the error and executing a second problem processing program, if the data is found to be incorrect after used, if the voting results show that the participants who confirm that the data Mᵢ is incorrect account for a proportion of all the participants exceeds a second predetermined threshold, firstly all the participants vote to determine whether it is necessary to find the data transmission source that writes the incorrect data. If the voting results show that the participants who consider that the data transmission source that writes the incorrect data needs to be sought account for a proportion of all the participants exceeds a third predetermined threshold, all the participants perform ring signatures on the incorrect data to find the data transmission source that writes the incorrect data.

The present invention is further illustrated by specific embodiments below.

FIG. 5 shows a schematic workflow diagram of a data sharing system according to an embodiment of the present invention. As shown in FIG. 5, the data sharing system according to the embodiment of the present invention includes four participants. The four participants are commonly connected to a blockchain supporting basic read and write operations to share data. Each participant has abilities of generating and verifying a ring signature, generating a public-private key pair and jointly maintaining a closed blockchain. The closed blockchain means that, except for the participants, no one can write data into the blockchain or read data from the blockchain.

Continuing to reference to FIG. 5, the workflow of the data sharing system according to the embodiment of the present invention includes the following steps.

51: using an elliptic curve cryptography, by each of the four participants, to generate a public-private key pair representing an identity of the participant, public keys PK₁, PK₂, PK₃, PK₄ and private keys SKᵢ, SK₂, SK₃, SK₄ corresponding to the public keys being included in the public-private key pairs; publishing, by each participant, the public key PKᵢ corresponding to the identity of the participant and recording all the published public keys PK₁, PK₂, PK₃, PK₄.

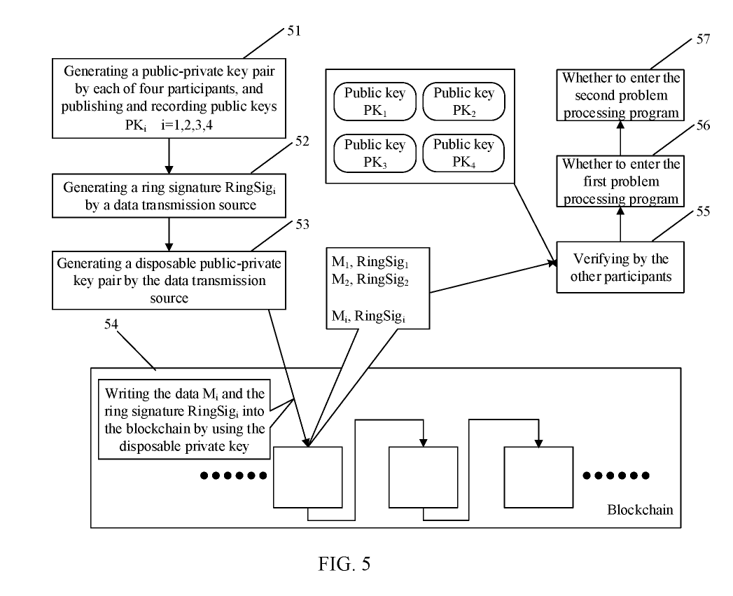

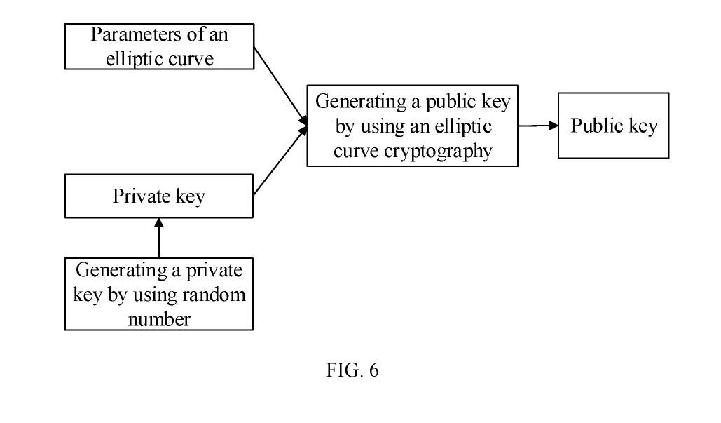

FIG. 6 shows a schematic diagram of a process of generating a public-private key pair of a data sharing system according to an embodiment of the present invention. As shown in FIG. 6, the main process of generating the public-private key pair includes: firstly generating a private key (the private key is a large random number), and then generating a public key by defining parameters of the elliptic curve and inputting the private key into the elliptic curve. The elliptic curve cryptography for generating the public-private key pair refers to national standard SM2 algorithm.

52: generating a ring signature RingSigᵢ, by a data transmission source of the four participants, by using a ring signature algorithm according to the public keys PK₁, PK₂, PK₃, PK₄ of all the participants, a private key of the data transmission source and data Mᵢ to be sent, when the data transmission source of the four participants intends to send the data Mᵢ to other participants.

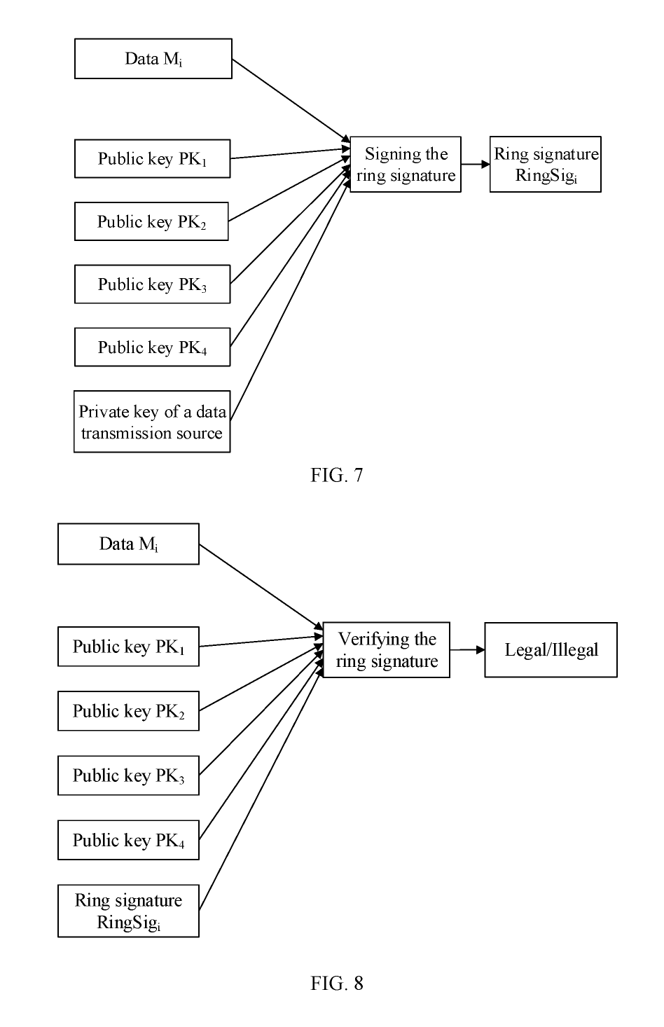

FIG. 7 shows a schematic diagram of a process of generating a ring signature of a data sharing system according to an embodiment of the present invention. As shown in FIG. 7, the main process of generating the ring signature includes signing the ring signature, according to the public keys PK₁, PK₂, PK₃, PK₄ of all the participants, the private key of the data transmission source and the data Mᵢ to be sent, to generate the ring signature RingSigᵢ.

In an embodiment of the present invention, the ring signature RingSigᵢ refers to a linkable ring signature.

53: generating a disposable public-private key pair, by the data transmission source, by using the elliptic curve cryptography. A process of generating the disposable public-private key pair can also refer to FIG. 6. That is, a disposable private key is generated firstly, the disposable private key is a large random number, and then a disposable public key is generated by defining the parameters of the elliptic curve and inputting the disposable private key into the elliptic curve. The elliptic curve of the disposable public-private key pair may need to match the elliptic curve used in the blockchain, that is, the elliptic curve of the disposable public-private key pair and the elliptic curve used in the blockchain belong to the same kind of elliptic curve.

54: signing a transaction Tx to write the data Mᵢ and the ring signature RingSigᵢ into the blockchain by using the disposable private key.

55: reading the data Mᵢ and the ring signature RingSigᵢ from the blockchain, by other participants who intend to use the data Mᵢ, and then verifying the ring signature RingSigᵢ by using a ring signature verification algorithm according to the public keys PK₁, PK₂, PK₃, PK₄, the data Mᵢ and the ring signature RingSigᵢ.

FIG. 8 shows a schematic diagram of a process of verifying a ring signature of a data sharing system according to an embodiment of the present invention. As shown in FIG. 8, the main process of verifying the ring signature includes verifying the ring signature according to the public keys PK₁, PK₂, PK₃, PK₄, the data Mᵢ and the ring signature RingSigᵢ to obtain a verification result. The verification result is legal or illegal.

56: using the data Mᵢ if the verification result is legal, and doing not use the data Mᵢ and entering into a first problem processing program if the verification result is illegal. The first problem processing program includes: reserving a set time period for the data transmission source to claim an error, if no one claims the error beyond the set time period, recording the number of verification results that are illegal within a period of time, if the number does not exceed a first predetermined threshold, ignoring that the verification is illegal by each participant, if the number exceeds the first predetermined threshold, stopping the data sharing in the blockchain.

57: reporting the error and entering into a second problem processing program, if the data Mᵢ is found to be incorrect after used. The second problem processing program includes: reserving a set time period for data transmission source to claim the error, if no one claims the error beyond the set time period, voting to confirm whether the data Mᵢ is incorrect by all participants, if the voting results show that the participants who confirm that the data Mᵢ is incorrect account for a proportion of all the participants exceeds a second predetermined threshold, voting by all the participants firstly to determine whether it is necessary to find the data transmission source that writes the incorrect data, if the voting results show that the participants who consider that the data transmission source that writes the incorrect data needs to be sought account for a proportion of all the participants exceeds a third predetermined threshold, all the participants perform ring signatures on the incorrect data to find the data transmission source that writes the incorrect data. For example, each of all the participants writes a linkable ring signature for the data, and digitally signs the linkable ring signature to prove an identity of the participant. A person who does not submit the linkable ring signature or provides the linkable ring signature linked to a known linkable ring signature receives a corresponding punishment.

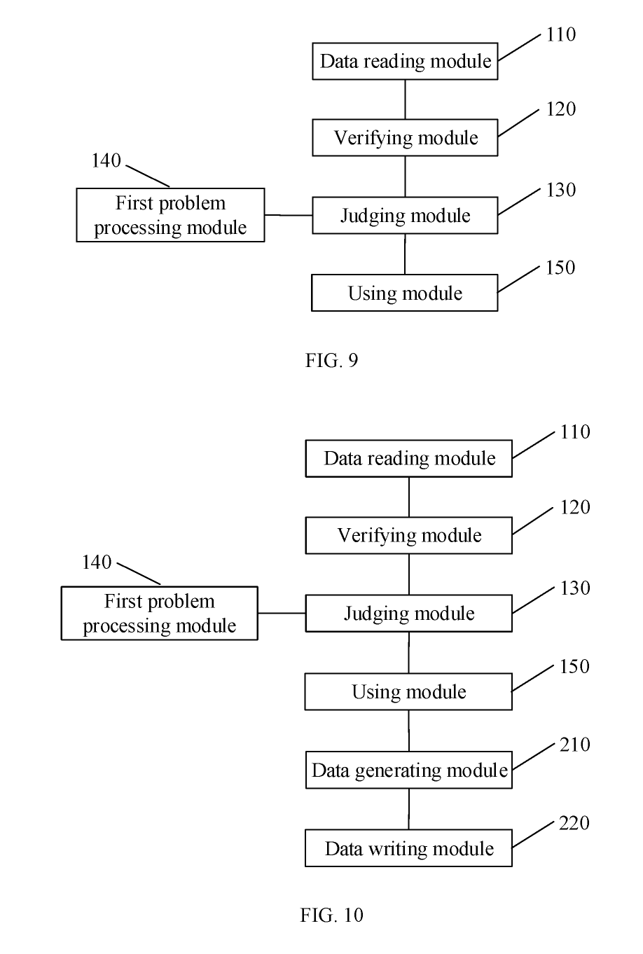

FIG. 9 shows a schematic structural diagram of a data sharing system according to an embodiment of the present invention. As shown in FIG. 9, the data sharing system according to the embodiment of the present invention includes: a data reading module 110, a verifying module 120, a judging module 130, a first problem processing module 140 and a using module 150.

The data reading module 110 is configured to read, by a second participant of a plurality of participants participating in data sharing, first data and a first ring signature from a blockchain. Each of the plurality of participants has a key pair, and the key pair includes a public key and a private key matching the public key. The first ring signature is generated by a first participant of the plurality of participants by using a ring signature algorithm according to public keys of the plurality of participants, a private key of the first participant and the first data. The first data and the first ring signature are written into the blockchain. The verifying module 120 is configured to verify, by the second participant, the first ring signature by using a ring signature verification algorithm according to the public keys of the plurality of participants, the first data and the first ring signature. The judging module 130 is configured to verify, by the second participant, whether the first ring signature is legal. The first problem processing module 140 is configured to execute a first problem processing program when the first ring signature is verified to be illegal by the second participant. The using module 150 is configured to use the first data when the first ring signature is verified to be legal by the second participant.

FIG. 10 shows a schematic structural diagram of a data sharing system according to another embodiment of the present invention. As shown in FIG. 10, the data sharing system according to the embodiment of the present invention further includes: a data generating module 210 and a data writing module 220. The data generating module 210 is configured to generate a second ring signature, by a second participant, by using a ring signature algorithm according to public keys of a plurality of participants, a private key of the second participant and second data. The data writing module 220 is configured to write the second data and the second ring signature into the blockchain.

In an embodiment of the present invention, the data generating module 210 includes a generating unit and a writing unit. The generating unit is configured to generate a disposable public-private key pair by the second participant; and the writing unit is configured to write the second data and the second ring signature into the blockchain by the second participant by using the disposable public-private key pair.

In an embodiment of the present invention, the first problem processing module 140 includes a first threshold determining unit. The first threshold determining unit is configured to execute a first problem processing program when the number of times that the first ring signature is verified to be illegal by the second participant is greater than a first threshold.

In another embodiment of the present invention, the first threshold determining unit includes a stop sharing subunit. The stop sharing subunit is configured to stop the data sharing in the blockchain when the number of times that the first ring signature is verified to be illegal by the second participant is greater than the first threshold within a first predetermined time.

In another embodiment of the present invention, the first threshold determining unit further includes a first claim subunit and a recording subunit. The first claim subunit is configured to set a second predetermined time by the second participant for claiming an error by a first participant. The recording subunit is configured to record the number of times that the first ring signature is verified to be illegal within the first predetermined time, by the second participant, if the first participant does not claim the error within the second predetermined time.

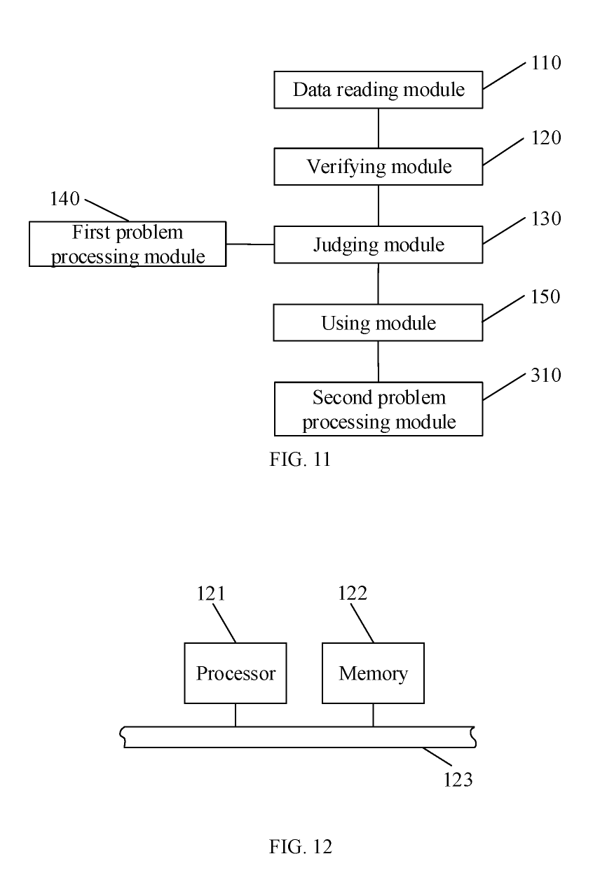

FIG. 11 shows a schematic structural diagram of a data sharing system according to still another embodiment of the present invention. As shown in FIG. 11, the data sharing system according to the embodiment of the present invention further includes: a second problem processing module 310. The second problem processing module 310 is configured to report the error and execute a second problem processing program if the first data is found to be incorrect after used by the second participant.

In an embodiment of the present invention, the second problem processing module 310 includes a voting unit and a seeking unit. The voting unit is configured to vote to confirm whether the first data is incorrect by the second participant and other participants of the plurality of participants. The seeking unit is configured to perform ring signatures on the first data to find a first participant, by the second participant and the other participants of the plurality of participants when the participants who confirm that the first data is incorrect account for a proportion of all the participants exceeds a second threshold.

In another embodiment of the present invention, the voting unit includes a second claim subunit and a first voting subunit. The second claim subunit is configured to set a third predetermined time, by the second participant, for claiming the error by the first participant. The first voting subunit is configured to vote, by the second participant and other participants of the plurality of participants, to confirm whether the first data is incorrect if the first participant does not claim the error within the third predetermined time.

In another embodiment of the present invention, the seeking unit includes a second voting subunit and a seeking subunit. The second voting subunit is configured to vote, by the second participant and the other participants of the plurality of participants, to determine whether it is necessary to seek the first participant. The seeking subunit is configured to perform the ring signatures on the first data, by the second participant and the other participants of the plurality of participants, to find the first participant, if voting results show that the participants consider that the first participant needs to be sought account for a proportion of all the participants exceeds a third threshold.

It may be understood that, in the data sharing system shown in FIGS. 5 to 11, operations and functions of the data reading module 110, the verifying module 120, the judging module 130, the first problem processing module 140, the using module 150, the data generating module 210, the data writing module 220, and the second problem processing module 310, and units, subunits, etc. included in each module may refer to the data sharing method shown in the forgoing FIGS. 1 to 4. It will not be described redundantly herein so as to avoid redundancy.

FIG. 12 shows a schematic structural diagram of an electronic equipment according to an embodiment of the present invention. The electronic equipment provided in FIG. 12 is used for performing the data sharing methods described in the embodiments of FIG. 1 to FIG. 4. As shown in FIG. 12, the electronic equipment includes a processor 121, a memory 122 and a bus 123.

The processor 121 is configured to call a code stored in the memory 122 through the bus 123 to read, by a second participant of a plurality of participants participating in data sharing, first data and a first ring signature from a blockchain, and verify, by the second participant, the first ring signature by using a ring signature verification algorithm according to the public keys of the plurality of participants, the first data and the first ring signature, and use the first data when the second participant verifies that the first ring signature is legal. Each of the plurality of participants has a key pair, and the key pair includes a public key and a private key matching the public key. The first ring signature is generated by a first participant of the plurality of participants by using a ring signature algorithm according to public keys of the plurality of participants, a private key of the first participant and the first data. The first data and the first ring signature are written into the blockchain

It may be understood that the electronic equipment includes, but is not limited to, an electronic equipment such as a mobile phone, a tablet computer and so on.

In an embodiment of the present invention, a computer readable storage medium is further provided. A data sharing program is stored in the computer readable storage medium. When the data sharing program is executed by a processor, the data sharing method mentioned in any one of the above embodiments is realized.

It may be understood that the computer readable storage medium refers to a memory such as a CD-ROM, a floppy disk, a hard disk, a Digital Versatile Disc (DVD), a blue-ray disc and so on. Alternatively, some or all operations of the examplary methods in FIGS. 1 to 4 may be implemented according to any combination of an Application Specific Integrated Circuit (ASIC), a Programmable Logic Device (PLD), an Erasable Programmable Logic Device (EPLD), a discrete logic, a hardware, a firmware and so on. In addition, although the flowcharts shown in FIGS. 1 to 4 describe the data sharing method, an operation in the data sharing method may be modified, deleted, or merged.

As described above, any examplary process of FIGS. 1 to 4 may be implemented according to a coded instruction (such as a computer readable instruction). The coded instruction is stored on a tangible computer readable storage medium such as a hard disk, a flash memory, a Read Only Memory (ROM), a Compact Disc (CD), a DVD, a cache, a Random Access Memory (RAM) and/or any other storage mediums. In the tangible computer readable storage medium, information may be stored for any time (such as long time, permanence, transience, temporary buffering, and/or caching of information). As used herein, the term tangible computer readable storage medium is expressly defined to include any type of computer readable storage signals. Additionally or alternatively, the examplary process of FIG. 1 may be implemented according to the coded instruction (such as the computer readable instructions) stored on a non-transitory computer readable storage medium such as a hard disk, a flash memory, a ROM, a CD, a DVD, a cache, a RAM and/or any other storage mediums. In the non-transitory computer readable storage medium, information may be stored for any time (such as long time, permanence, transience, temporary buffering, and/or caching of information).

In addition, it may also be noted that, a combination mode of technical features in the present invention is not limited to a combination mode recorded in claims of the present invention or a combination mode recorded in the specific embodiments. All the technical features recorded in the present invention may be freely combined or united in any way, unless there is a contradiction between the technical features.

It may be noted that the above embodiments are only specific embodiments of the present invention. The present invention is not limited to the above embodiments. and there are many similar variations follow. All variants derived or associated directly, by those skilled in the art, from the contents disclosed by the present invention can fall in the protection scope of the present invention.

What is claimed is:

1. A data sharing method, comprising:
reading, by a second participant of a plurality of participants participating in data sharing, first data and a first ring signature from a blockchain, wherein each of the plurality of participants has a key pair, and the key pair comprises a public key and a private key matching the public key, the first ring signature is generated by a first participant of the plurality of participants by using a ring signature algorithm according to public keys of the plurality of participants, a private key of the first participant and the first data, and the first data and the first ring signature are written into the blockchain;
verifying, by the second participant, the first ring signature by using a ring signature verification algorithm according to the public keys of the plurality of participants, the first data and the first ring signature; and
using the first data when the second participant verifies that the first ring signature is legal.

2. The data sharing method according to claim 1, further comprising:
generating a second ring signature, by the second participant, by using the ring signature algorithm according to the public keys of the plurality of participants, a private key of the second participant and second data; and
writing the second data and the second ring signature into the blockchain.

3. The data sharing method according to claim 2, wherein the writing the second data and the second ring signature into the blockchain comprises:
generating a disposable public-private key pair by the second participant; and
writing the second data and the second ring signature into the blockchain by the second participant by using the disposable public-private key pair.

4. The data sharing method according to claim 1, further comprising:
executing a first problem processing program when the second participant verifies that the first ring signature is illegal.

5. The data sharing method according to claim 4, wherein the executing a first problem processing program when the second participant verifies that the first ring signature is illegal comprises:
executing the first problem processing program when the number of times that the first ring signature is verified to be illegal by the second participant is greater than a first threshold.

6. The data sharing method according to claim 5, wherein the executing the first problem processing program when the number of times that the first ring signature is verified to be illegal by the second participant is greater than a first threshold comprises:
stopping the data sharing in the blockchain when the number of times that the first ring signature is verified to be illegal by the second participant is greater than the first threshold within a first predetermined time.

7. The data sharing method according to claim 6, wherein before the stopping the data sharing in the blockchain when the number of times that the first ring signature is verified to be illegal by the second participant is greater than the first threshold within a first predetermined time, the method further comprises:
setting a second predetermined time, by the second participant for claiming an error by the first participant; and
recording the number of times that the first ring signature is verified to be illegal within the first predetermined time by the second participant, if the first participant does not claim the error within the second predetermined time.

8. The data sharing method according to claim 1, further comprising:
reporting an error and executing a second problem processing program, if the second participant finds that the first data is incorrect after using the first data.

9. The data sharing method according to claim 8, wherein the reporting an error and executing a second problem processing program, if the second participant finds that the first data is incorrect after using the first data comprises:
voting, by the second participant and other participants of the plurality of participants, to confirm whether the first data is incorrect; and
performing ring signatures on the first data to find the first participant, by the second participant and the other participants of the plurality of participants, when a proportion of participants that confirm the first data is incorrect exceeds a second predetermined threshold.

10. The data sharing method according to claim 9, wherein the voting, by the second participant and other participants of the plurality of participants, to confirm whether the first data is incorrect comprises:
setting a third predetermined time, by the second participant, for claiming the error by the first participant; and
voting, by the second participant and other participants of the plurality of participants, to confirm whether the first data is incorrect if the first participant does not claim the error within the third predetermined time.

11. The data sharing method according to claim 9, wherein the performing ring signatures on the first data to find the first participant by the second participant and the other participants of the plurality of participants comprises:
voting, by the second participant and the other participants of the plurality of participants to determine whether it is necessary to seek the first participant; and
performing the ring signatures on the first data, by the second participant and the other participants of the plurality of participants, to find the first participant if a proportion of voting results showing that the first participant needs to be sought exceeds a third predetermined threshold.

12. A data sharing system, comprising a memory, a processor, and a computer program stored in the memory and executed by the processor, wherein when the computer program is executed by the processor, the processor implements the following steps:
reading, by a second participant of a plurality of participants participating in data sharing, first data and a first ring signature from a blockchain, wherein each of the plurality of participants has a key pair, and the key pair comprises a public key and a private key matching the public key, the first ring signature is generated by a first participant of the plurality of participants by using a ring signature algorithm according to public keys of the plurality of participants, a private key of the first participant and the first data, and the first data and the first ring signature are written into the blockchain;
verifying, by the second participant, the first ring signature by using a ring signature verification algorithm according to the public keys of the plurality of participants, the first data and the first ring signature;
verifying whether the first ring signature is legal by the second participant; and
using the first data when the second participant verifies that the first ring signature is legal.

13. The data sharing system according to claim 12, wherein the processor further implements the following steps:
generating a second ring signature, by the second participant, by using the ring signature algorithm according to the public keys of the plurality of participants, a private key of the second participant and second data; and
writing the second data and the second ring signature into the blockchain.

14. The data sharing system according to claim 12, the processor further implements the following step:
executing a first problem processing program when the second participant verifies that the first ring signature is illegal.

15. The data sharing system according to claim 14, wherein when implementing the step of executing a first problem processing program when the second participant verifies that the first ring signature is illegal, the processor specifically implements the following step:
executing the first problem processing program when the number of times that the first ring signature is verified to be illegal by the second participant is greater than a first threshold.

16. The data sharing system according to claim 15, wherein when implementing the step of executing the first problem processing program when the number of times that the first ring signature is verified to be illegal by the second participant is greater than a first threshold, the processor specifically implements the following step:
stopping the data sharing in the blockchain when the number of times that the first ring signature is verified to be illegal by the second participant is greater than the first threshold within a first predetermined time.

17. The data sharing system according to claim 12, wherein the processor further implements the following step:
reporting an error and executing a second problem processing program, if the second participant finds that the first data is incorrect after using the first data.

18. The data sharing system according to claim 17, wherein when implementing the step of reporting an error and executing a second problem processing program, if the second participant finds that the first data is incorrect after using the first data, the processor specifically implements the following steps:
voting, by the second participant and other participants of the plurality of participants, to confirm whether the first data is incorrect; and
performing ring signatures on the first data to find the first participant, by the second participant and the other participants of the plurality of participants, when a proportion of participants that confirm the first data is incorrect exceeds a second predetermined threshold.

19. The data sharing system according to claim 18, wherein when implementing the step of reporting an error and executing a second problem processing program, if the second participant finds that the first data is incorrect after using the first data, the processor specifically further implements the following steps:
setting a third predetermined time, by the second participant, for claiming the error by the first participant; and
voting, by the second participant and other participants of the plurality of participants, to confirm whether the first data is incorrect if the first participant does not claim the error within the third predetermined time.

20. A computer readable storage medium storing a data sharing program for causing a processor to execute the data sharing method according to claim 1.
